(19) United States
(12) Patent Application Publication
(10) Pub. No.: US 2011/0261786 A1
(43) Pub. Date: Oct. 27, 2011

(54) RESTRICTING HANDOVER OF A MOBILE STATION

(76) Inventors: Chandra Bontu, Nepean (CA); Surya Tenneti, Frisco, TX (US); Devaki Chandramouli, Plano, TX (US); David Anderson, Calgary (CA)

(21) Appl. No.: 12/988,360

(22) PCT Filed: Apr. 22, 2009
(86) PCT No.: PCT/US09/41427

§ 371 Date: Jan. 4, 2011

Related U.S. Application Data
(60) Provisional application No. 61/046,942, filed on Apr. 22, 2008.

(51) Int. Cl. H04W 36/00

(52) U.S. Cl. 370/331

(57) ABSTRACT

A base station communicates, with a mobile station, data associated with a packet-switched session in which the mobile station is involved. In response to a handover request from the mobile station, the base station accesses information provisioned for the mobile station to determine whether the mobile station is to be subjected to mobility restriction. Based on the accessed information, the base station determines whether to allow handover of the mobile station. A message is sent to the mobile station to indicate that the requested handover is not allowed if the base station determines that the requested handover is not allowed.

### TECHNICAL FIELD

The invention relates generally to restricting handover of a mobile station.

### BACKGROUND

A wireless communications network typically allows mobile stations to freely move about coverage areas associated with the wireless communications network. Various wireless access technologies have been proposed or implemented to enable mobile stations to perform communications with other mobile stations or with wired terminals coupled to wired networks. Examples of wireless access technologies include GSM (Global System for Mobile communications) or UMTS (Universal Mobile Telecommunications System) technologies, defined by the Third Generation Partnership Project (3GPP); CDMA 2000 (Code Division Multiple Access 2000) technologies, defined by 3GPP2; or other wireless access technologies. The CDMA 2000 family of wireless access technologies includes the 1×RTT wireless access technology (generally used to perform circuit-switched communications), and the 1×EV DO (or EV-DO) wireless access technology (used for communication of packet data and defined by the High Rate Packet Data (HRPD) specification, also known as the IS 856 specification).

As part of the continuing evolution of wireless access technologies to improve spectral efficiency, to improve services, to lower costs, and so forth, new standards have been proposed. One such new standard is the Long Term Evolution (LTE) standard from 3GPP, which seeks to enhance the UMTS wireless network.

Another type of wireless access technology is the WiMax (Worldwide Interoperability for Microwave Access) technology. WiMax is based on the IEEE (Institute of Electrical and Electronics Engineers) 802.16 Standard. The WiMax wireless access technology is designed to provide wireless broadband access.

Conventionally, standards have not provided efficient mechanisms to restrict mobility of mobile stations.

### SUMMARY

In general, according to an embodiment, a base station communicates, with a mobile station, data associated with a packet-switched session in which the mobile station is involved. In response to a handover request from the mobile station, the base station accesses information provisioned for the mobile station to determine whether the mobile station is to be subjected to mobility restriction. Based on the accessed information, the base station determines whether to allow handover of the mobile station. A message is sent to the mobile station to indicate that the handover request is not allowed if the base station determines that the requested handover is not allowed.

Other or alternative features will become apparent from the following description, from the drawings, and from the claims.

### BRIEF DESCRIPTION OF THE DRAWINGS

FIG. 1 is a block diagram of an exemplary arrangement that includes base stations that are able to perform restricted mobility handover according to preferred embodiments.

FIGS. 2-5 are message flow diagrams illustrating procedures for performing restricted handovers, according to preferred embodiments.

### DETAILED DESCRIPTION OF THE PREFERRED EMBODIMENTS

In certain contexts, it may be desirable to restrict the mobility of mobile stations. For example, a service provider may have been given a license by a government agency or other regulatory body to provide mobility only within a certain geographic region. Alternatively, a service provider may define different levels of services, with one service level specifying that subscribers are free to move about the entire coverage area of a mobile communications network provided by the service provider, and another service level specifying that subscribers are provided with restricted mobility.

In accordance with preferred embodiments, restricted mobility handover is performed by base stations in a mobile or wireless communications network that provides packet-switched services. The wireless communications network includes base stations that provide corresponding coverage areas (sometimes referred to cells or cell sectors) in which mobile stations are able to perform wireless access of the wireless communications network. The base stations are able to provide for restricted mobility handover of at least some of the mobile stations within the wireless communications network. Restricted mobility handover refers to handover in which the base stations check to determine whether predefined criteria specifies that handover requests made by a mobile station are to be denied.

For a given restricted mobility mobile station, when a base station receives a handover request from such mobile station, the base station accesses information provisioned for the mobile station to determine whether the mobile station is to be subjected to mobility restrictions. Based on the accessed information, the base station determines whether to allow handover of the mobile station. In response to determining that the requested handover is not allowed, the base station sends a message to the mobile station indicating that the handover request is denied or not recommended.

As noted above, the restricted mobility provided for mobile stations is provided by a mobile communications network that enables provision of packet-switched services to the mobile station. An example of a packet-switched service is a packet-switched communications session for communicating voice, data, video, or other traffic using a packet-switched communications protocol.

Examples of wireless technologies that support packet-switched communications services include the WiMax (Worldwide Interoperability for Microwave Access) technology, as defined by the IEEE (Institute of Electrical and Electronics Engineers) 802.16 standards; or the Long Term Evolution (LTE) technology from 3GPP. The above wireless access technologies are examples of wireless access technologies that support 4G (fourth generation and beyond) packet-switched services. 4G wireless access technologies are designed to accommodate the quality of service (QoS) and data rate requirements of applications such as wireless broadband access, multimedia messaging service, video chat, mobile television (TV), HDTV (high definition television) content, digital video broadcasting (DVB), along with more traditional voice over IP (Internet Protocol) services. 4G wireless access provides higher bandwidth and data rates than available with prior generation 3G or less wireless access technologies.

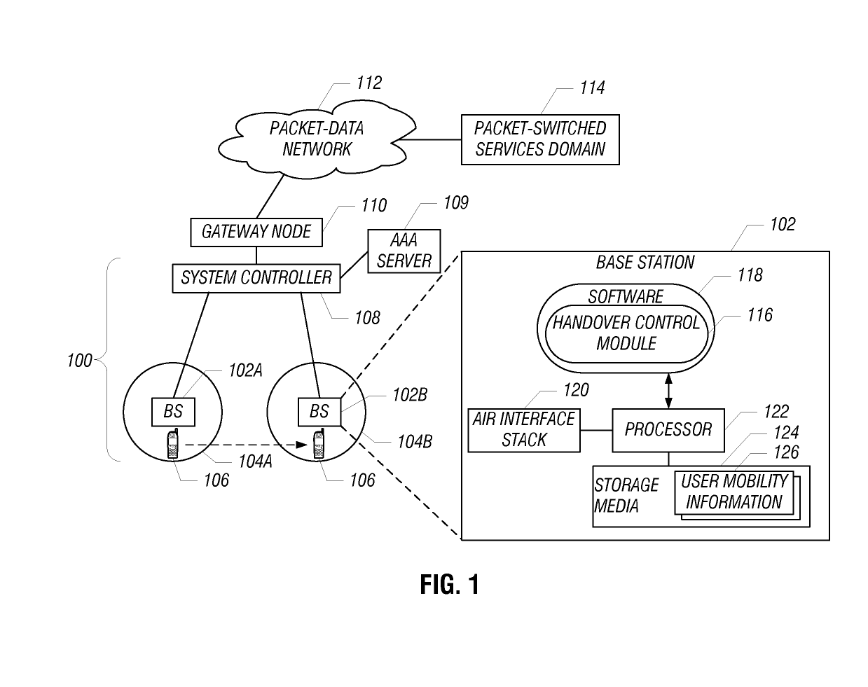

FIG. 1 shows a communications arrangement that includes a wireless access network 100 that has base stations 102A and 102B. Although just two base stations are shown in FIG. 1, it is noted that additional base stations can be provided in other implementations. Each base station 102A and 102B provides a corresponding coverage area 104A, 104B (sometimes referred to as cells or cell sectors). When a mobile station 106 is located in coverage area 104A, the mobile station 106 communications over an air interface between the mobile station 106 and the base station 102A. On the other hand, if the mobile station 106 moves to the coverage area 104B, then the mobile station 106 would perform communications over the air interface with the base station 102B.

Each base station 102A, 102B is connected to a system controller 108. If the wireless access network 100 is a WiMax wireless access network, then the system controller 108 can be an access service network (ASN) gateway. The system controller 108 is in turn connected to a gateway node 110, which connects the wireless access network 100 to an external packet data network 112, such as the Internet. In the WiMax context, the gateway node 110 is referred to as a connectivity service network (CSN) node.

Alternatively, if the wireless access network 100 is an LTE wireless access network, then the nodes 108 and 110 are referred to by other names.

In one example, a packet-switch services domain 114 can be connected to the packet data network 112. One example of a packet-switched services domain is the domain provided by the Internet Protocol (IP) Multimedia System (IMS), as defined by 3GPP. IMS defines various control functions to allow for provision of packet-switched services. The control functions of the packet-switched services domain 114 can establish packet-switched communications sessions in response to control messages, such as control messages according to the Session Initiation Protocol (SIP). SIP is defined by Request For Comments (RFC) 3261, entitled “SIP: Session Initiation Protocol,” dated June 2002.

The mobile station 106 can establish a packet-switched session or access other packet-switched services through the wireless access network 100 and using control functions of the packet-switched services domain 114.

In accordance with preferred embodiments, each base station 102A, 102B is able to perform restricted handover procedures for restricted mobility mobile stations. As shown in FIG. 1, each base station 102 includes a handover control module 116 that provides the restricted mobility handover for restricted mobility mobile stations. The handover control module 116 can be part of software 118 in the base station 102. The base station further includes an air interface stack 120 to allow for wireless communications over the air interface with mobile stations within the coverage area of the base station 102.

The software 118 of the base station is executable on a processor 122 in the base station. The processor 122 is connected to storage media 124. In accordance with preferred embodiments, the storage media 124 stores user mobility information 126 that can specify that restricted mobility is to be provided for the user. The user mobility information 126 is provisioned for a particular mobile station (individual subscriber). For multiple mobile stations (subscribers), there would be multiple instances of the user mobility information 126. In response to a handover request from a particular mobile station, the handover control module 116 in the base station 102 accesses the user mobility information 126 that has been provisioned for the particular mobile station to determine whether restricted mobility is to be applied, and if so, what criterion(ia) is (are) to be used for restricting mobility in deciding whether or not to deny the handover request.

Provisioning of the user mobility information 126 for each given mobile station can be performed when the subscriber makes a network entry into the coverage area of the base station, either by establishing a call (by originating a call or accepting a call) or by being handed over from another base station. When making initial network entry, a mobile station performs a registration procedure with an AAA server 109 to perform authentication of the mobile station and to authorize services to be provided to the mobile station. As part of this procedure, the AAA server 109 can provide information to indicate whether mobility of the mobile station is to be restricted, and if so, what criteria to apply.

Instead of the AAA server 109, authentication and authorization on behalf of a mobile station can be performed by accessing an HLR (home location register) or HSS (home subscriber server). Generally, an AAA server, HLR, or HSS can be referred to as an “authentication server.”

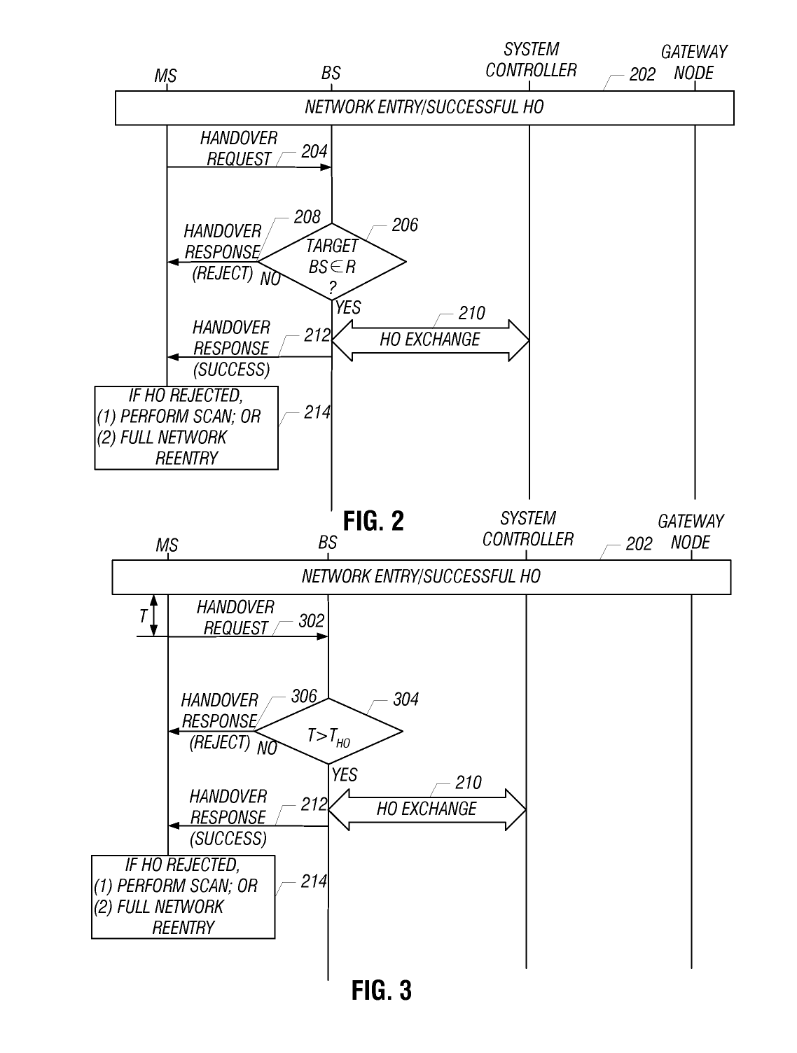

FIG. 2 shows a restricted handover procedure according to a first preferred embodiment. The message flow of FIG. 2 restricts handover based on a list of neighbors, R. The list of neighbors R is provisioned for a given mobile station. In other words, there will be multiple lists of neighbors provisioned for multiple corresponding mobile stations.

A block 202 represents an exchange of messages for network entry by the given mobile station or a successful handover by the given mobile station. As part of network entry, the AAA server 109 of FIG. 1 can send an MS mobility classification flag (or other indicator) to the base station. The MS mobility classification flag indicates whether the mobile station is a restricted mobility mobile station or a full mobility mobile station. The MS mobility classification flag can be stored as part of the user mobility information 126 stored by the base station. The AAA server 109 can also provide other information to the base station regarding the restricted mobility, such as the criteria to apply for the restricted mobility. As noted above, instead of the AAA server 109, another entity, such as an HLR or HSS, can provision the user mobility information 126 for the given mobile station.

When the mobile station detects that handover from the present base station to which the mobile station is attached (source base station) to another base station (target base station) is required, the mobile station sends (at 204) a handover request. Handover may be required if the mobile station detects that the strength of radio signals between the mobile station and the source base station are weak, or for any other reason. In one embodiment, if the wireless access network 100 is a WiMax wireless access network, then the handover request can be MOB MSHO-REQ request. Upon receiving the handover request, the base station accesses the user mobility information 126 for the given mobile station to determine if the mobile station is subjected to restricted mobility, and if so, the base station accesses a list of neighbors, R, included in the user mobility information 126. The base station determines (at 206) if the requested target base station(s) is (are) part of the list of neighbors, R. If not, a handover response is sent (at 208) rejecting the handover request sent at 204. In one embodiment, the response message can be an MOB BSHO-RSP message that contains the HO reject indication. Alternatively, if handover is determined to be not allowed, the source base station can send a handover response with a HO not recommended indication.

However, if the target base station(s) is (are) part of the list of neighbors R, then the handover request is allowed, and the base station performs (at 210) an exchange of messaging with the system controller 108, to complete the handover of the mobile station from the source base station to the target base station. Although not shown in FIG. 2, the system controller 108 performs a corresponding exchange of handover messaging with the target base station. Exchanging handover messaging through the system controller 108 between the source and target base stations is referred to as R6 HO messaging (in the WiMax context). In an alternative implementation, there can be a direct connection (referred to as an R8 connection in the WiMax context) between the source and target base stations. In this alternative implementation, handover messaging is exchanged directly between the source and target base stations (which is referred to as R8 HO messaging in the WiMax context).

As part of the exchange of messaging between the source base station and the target base station to perform handover of the mobile station, the mobile station context is transferred to the target base station. The mobile station context includes the security context of the mobile station so that the target base station does not need to perform authentication again. Also, the mobile station context includes other mobile station-related parameters that are required for the network entry of the target base station. Also included in the mobile station context transfer is the user mobility information 126.

Once the target base station is ready to receive the mobile station, the source base station sends (at 212) a handover response message to the mobile station to indicate that the mobile station can now be successfully handed over to the target base station.

In response to receiving a response (208) indicating that handover is not allowed, the mobile station can perform (at 214) one of two actions. First, the mobile station can perform a scan of all frequencies to determine which frequencies are available for sending a handover request. The mobile station can use this scan to identify another base station to which the mobile station can send the handover request. Alternatively, the mobile station can disconnect the call and perform a full network reentry at one of the target base stations of the mobile station's choice. In another implementation, if the response received from the source base station is a handover not recommended response, then the mobile station can stay with the current base station and request handover at a later time.

FIG. 3 is a message flow diagram of an alternative embodiment of performing restricted mobility handover. In this embodiment, the restriction of mobility is based on a different criterion (a time criterion). After network entry or successful handover (202), the mobile station detects handover from the source base station to another base station is required. In response, the mobile station sends (at 302) a handover request, where the handover request sent at 302 is a time T from the network entry or successful handover (202). In response to the handover request (302), the source base station accesses the provisioned user mobility information 126 for the mobile station, which contains a time threshold THO. The threshold THO specifies a time restriction that prevents the mobile station from being handed over if the mobile station requests a handover too soon after the mobile station made an initial network entry or after the latest successful handover. The source base station checks (at 304) if T (the time between network entry/successful handover and when the mobile station sent the handover request at 302) is greater than THO. If the condition at 304 is not true, then the mobile station has submitted a handover request too soon after network entry or successful handover, and a handover response is sent (at 306) to reject the handover request. In response to the denial of the handover request, the mobile station performs (at 214) the action discussed above. Alternatively, if the mobile station had received a response indicating that handover is not recommended, then the mobile station can retry the handover at a later time.

However, if T>THO, which indicates that the mobile station had requested handover after the restricted time (THO), then the source base station performs tasks 210 and 212 (discussed above) to complete the handover.

The value of THO can be set to a relatively large value to prevent the mobile station from moving too fast. Fast movement of the mobile station is inconsistent with the goal of providing restricted mobility to the mobile station. The value of THO can be based on the inter-coverage area distance and expected speed of slow-moving mobile stations (associated with users who are walking, for example).

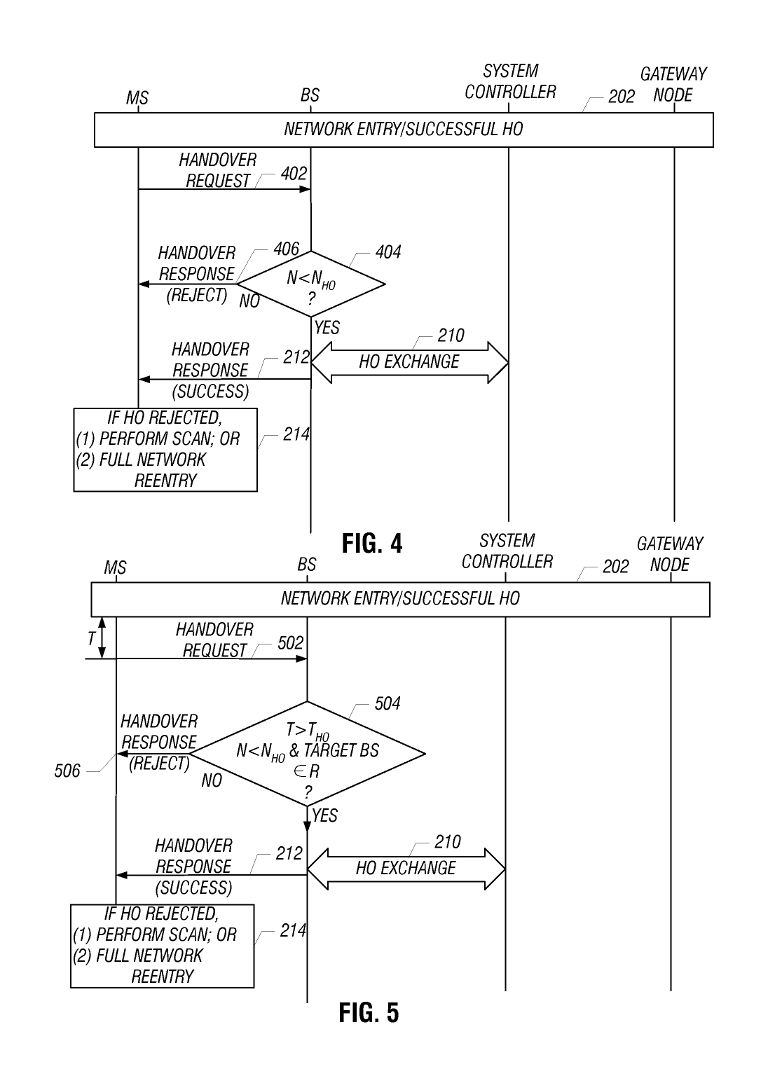

FIG. 4 is a message flow diagram of another embodiment of performing restricted mobility handover. After network entry or successful handover by the mobile station, the mobile station detects that handover is required, and sends (at 402) a handover request message. In response to receiving the handover request message, the source base station accesses the provisioned user mobility information for the mobile station, and retrieves a parameter NHO, which indicates a threshold number of handovers that are allowed for the mobile station. The source base station checks (at 404) if the count (N) of the number of handovers that have been performed for the mobile station is less than NHO. If not, then that indicates that the number (N) of handovers performed for the mobile station has exceeded the threshold NHO, the source base station sends (at 406) a handover response message rejecting the handover request. In response to the denial of the handover request, the mobile station performs (at 214) the action discussed above. Alternatively, if the mobile station had received a response indicating that handover is not recommended, then the mobile station can retry the handover at a later time. However, if N<NHO then the handover is allowed, and the tasks at 210 and 212 are performed.

FIG. 5 is a message flow diagram of an alternative embodiment. In this embodiment, each of the restricted mobility criteria described above in connection with FIGS. 2-5 are applied to determine whether or not a handover request from a mobile station is allowed. After network entry or successful handover (202), the mobile station detects a handover is required, and the mobile station sends (at 502) a handover request, at a time T after network entry/successful handover. The source base station, in response to the handover request, accesses user mobility information provisioned for the mobile station to determine whether the handover request is allowed. The source base station checks to determine if T>THO, and N<NHO, and the requested target base station(s) are part of a list of neighbors, R. If any of the three conditions is not true, then the handover request is rejected by sending a handover response (at 506) with a reject indication. In response to the denial of the handover request, the mobile station performs (at 214) the action discussed above. Alternatively, if the mobile station had received a response indicating that handover is not recommended, then the mobile station can retry the handover at a later time.

However, if all the conditions checked at 504 are true, then the handover is allowed, and the tasks at 210 and 212 are performed.

The granularity of mobility classification can also be increased at the AAA server 109 (or HLR or HSS). As noted above, a mobility classification flag is used to indicate whether or not the mobile station is subjected to restricted mobility or has full mobility. This can be a binary flag having one of two possible states. If greater granularity is desired, then the mobility classification flag can identify different classes of mobility restriction, such as mobility restriction for mobile stations that are close to a base station versus mobile stations that are located at a cell edge. Different mobility restriction criteria can be used to specify different mobility restrictions for these different classes.

The tasks above can be performed by software, such as by the handover control module 116 in FIG. 1. Instructions of such software are executed on a processor (e.g., processor 122). The processor includes microprocessors, microcontrollers, processor modules or subsystems (including one or more microprocessors or microcontrollers), or other control or computing devices. A “processor” can refer to a single component or to plural components (e.g., one CPU or multiple CPUs).

Data and instructions (of the software) are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
communicating, by a base station with a mobile station, data associated with a packet-switched session in which the mobile station is involved;
in response to a handover request from the mobile station, the base station accessing information provisioned for the mobile station to determine whether the mobile station is to be subjected to mobility restriction;
based on the accessed information, the base station determining whether to allow handover of the mobile station; and
sending a message to the mobile station to indicate that the handover request is not allowed if the base station determines that the requested handover is not allowed.

2. The method of claim 1, wherein determining whether to allow the handover is based on the accessed information identifying a set of neighbors to which the mobile station is allowed to be handed over.

3. The method of claim 1, wherein communicating data associated with the packet-switched session comprises communicating data associated with a 4G packet-switched session.

4. The method of claim 1, further comprising:
the base station receiving, upon network entry or successful handover of the mobile station, user mobility information that specifies if mobility restriction is to be applied for the mobile station.

5. The method of claim 4, wherein receiving the user mobility information comprises receiving the user mobility information from an authentication server.

6. The method of claim 4, wherein receiving the user mobility information comprises receiving the user mobility information that includes a mobility classification indicator that has one of plural values to indicate whether the mobile station is subjected to restricted mobility or is fully mobile.

7. The method of claim 4, further comprising:
sending, by the base station, the user mobility information as part of a mobile station context transfer during handover of the mobile station from the base station to another base station.

8. The method of claim 1, further comprising:
receiving, by the base station from the mobile station, a request to perform network reentry that is initiated by the mobile station in response to the requested handover being denied.

9. The method of claim 1, wherein determining whether to allow the handover is based on the accessed information identifying a predetermined time measured from network entry or completed handover, wherein the mobile station is allowed to be handed over to another base station if the handover request is received by the base station outside the predetermined time.

10. The method of claim 1, wherein determining whether to allow the handover is based on the accessed information identifying a number of handovers allowed for the mobile station.

11. The method of claim 1, wherein determining whether to allow the handover is based on the accessed information identifying a number of handovers allowed within a predefined time period.

12. The method of claim 1, wherein determining whether to allow the handover is based on the accessed information identifying a predetermined time measured from network entry or completed handover, a number of handovers allowed, and whether a target base station is in a list of neighbors.

13. An article comprising at least one machine-readable storage medium containing instructions that upon execution by a processor cause a base station to:
establish, on behalf of a mobile station, a packet-switched session;
receive a handover request from the mobile station;
in response to the handover request from the mobile station, access information provisioned for the mobile station to determine whether the mobile station is to be subjected to mobility restriction and whether to allow handover of the mobile station; and
send a message to the mobile station to indicate that the requested handover is not allowed if the base station determines that the requested handover is not allowed.

14. The article of claim 13, wherein the base station is part of one of a WiMax and LTE wireless access network.

15. The article of claim 13, wherein the accessed information includes a list of neighbors corresponding to base stations that the mobile station can be handed over to.

16. The article of claim 13, wherein the accessed information includes information specifying one or more of a time-based mobility restriction and a count-based mobility restriction.

17. The article of claim 16, wherein the time-based mobility restriction specifies that the mobile station is not allowed to perform handover within a specified time limit, and the count-based mobility restriction specifies that the mobile station is not allowed to perform more than a predetermined number of handovers.

18. A base station comprising:
an interface to perform wireless communications with a mobile station to establish a packet-switched communications session for the mobile station; and
a processor to:
receive a handover request from the mobile station;
in response to the handover request from the mobile station, access information provisioned for the mobile station to determine whether the mobile station is to be subjected to mobility restriction and whether to allow handover of the mobile station; and
send a message to the mobile station to indicate that the requested request is not allowed if the base station determines that the requested handover is not allowed.
